(19) United States
(12) Patent Application Publication
(10) Pub. No.: US 2006/0134510 A1
(43) Pub. Date: Jun. 22, 2006

(54) Air cell air flow control system and method

(76) Inventor: Cleopatra Cabuz, Eden Prairie, MN (US)

Correspondence Address: HONEYWELL INTERNATIONAL INC., 101 COLUMBIA ROAD, P O BOX 2245, MORRISTOWN, NJ, 07962-2245, US

(21) Appl. No.: 11/018,827

(22) Filed: Dec. 21, 2004

(51) Int. Cl. H01M 2/12; H01M 10/44

(52) U.S. Cl. 429/61; 429/82; 429/50

(57) ABSTRACT

Devices and methods for air flow impedance modulation or control. A flow impedance modification device may include a wall defining an opening and a flexible membrane for opening, closing, or impeding the opening. Electrodes disposed on the flexible membrane and near the flexible membrane are used to control the positioning and shape of the flexible membrane to change the flow impedance through the opening. Certain embodiments include methods of using such devices. Some embodiments include air cell batteries incorporating such control devices and methods.

### FIELD

The present invention is related to the field of flow control. More particularly, the present invention is related to devices and methods for controlling air flow for use in air cells.

### BACKGROUND

Air cells are a battery technology capable of providing a high capacity-to-volume ratio in miniature batteries. An air cell provides electricity using ambient air to provide molecules for a chemical reaction that creates an electric potential. Several chemical species of such batteries are in development or are already commercially available.

One commercially available air cell battery is shown in FIG. 1, which illustrates a Zinc-Air air cell battery. The illustration is based loosely on an Energizer® AC675 battery. Air is allowed to pass through an air hole, and oxygen in the air reacts with a gelled zinc power. The battery shown in FIG. 1 is designed for use in hearing aids and other small devices. Air cell batteries may also be used in industrial applications such as in embedded sensors.

Air cell batteries are typically packaged and sealed to prevent drying out of the reactive chemical prior to use. A tab seal provided over the air hole is considered to be relatively important as is preserves air cell fuel until the tab is removed and use begins. Once unsealed, performance can degrade quickly, particularly in humid or hot conditions. For some chemical species of air cells, high humidity is believed to infuse moisture that impedes the chemical reaction, while high heat is believed to dry out the cell, reducing output and accelerating degradation of capacity.

### SUMMARY

The present invention, in an illustrative embodiment, includes a battery comprising an air cell having an anode, a cathode, a substance reactive to air, an opening allowing for introduction of air to react with the substance, and a flow control device coupled to the opening and having an adjustable flow impedance for controlling air flow into the air cell. The illustrative flow control device comprises an opening, a first electrode, a flexible member, and a second electrode disposed on the flexible member, wherein the flexible member is configured to have a first position and a second position, the first position being a default position, the electrodes are placed such that a voltage applied between the electrodes can cause the flexible member to assume the second position due to an electrostatic force, and the first position and the second position create different flow impedances in the flow control device.

Another illustrative embodiment includes an air flow modification device comprising an outer casing having a plurality of outer openings therethrough, flexible membranes corresponding to each of the outer openings, each flexible membrane including a first electrode, and a plurality of second electrodes each corresponding to a first electrode. For this illustrative embodiment, the flexible membranes and second electrodes are disposed with respect to one another such that, for a given flexible membrane having a first electrode and a corresponding second electrode, the flexible membrane is moveable with respect to a corresponding outer opening to change the flow impedance through the corresponding outer opening in response to a voltage applied between the corresponding first and second electrodes. In a further embodiment, the outer casing is in the form of an outer cylinder, the device further comprising an inner cylinder to which the second electrodes and the flexible membranes are attached.

Yet another illustrative embodiment includes an air flow modification device comprising a first wall defining an opening, a second wall opposite the first wall, a flexible membrane secured to the first wall and disposed relative the opening, the flexible membrane being moveable to modify flow impedance through the opening, the flexible membrane including a first electrode, and a second electrode disposed relative the second wall. For this illustrative embodiment, the second electrode is disposed relative the flexible membrane such that application of a voltage between the first and second electrodes creates an electrostatic force modifying the flow impedance through the opening.

Another illustrative embodiment includes a method of modifying air flow comprising providing a chamber having a first wall having an opening and a second wall having a membrane secured thereto, the membrane including a first electrode and the second wall further having a second electrode, and selectively applying a voltage between the first and second electrodes to move the membrane using an electrostatic force to change the flow impedance through the opening.

Another illustrative method embodiment is adapted for controlling an air cell battery, the air cell battery having an inlet allowing for infusion of air, with the method comprising providing an air flow modification device coupled to the inlet, and modulating air flow through the inlet by adjusting air flow impedance through the air flow modification device. The air flow modification device may take the form of any of the several device embodiments discussed herein and further explained below.

### BRIEF DESCRIPTION OF THE DRAWINGS

FIG. 1 is a cross sectional view of an illustrative prior art air cell battery;

FIGS. 2A-2B are plan views for an air flow modification device;

FIGS. 3A-3B are transverse cross sectional views through a cylindrical air flow modification device as shown in FIG. 3C;

FIG. 3C is a front elevation view of a cylindrical air flow modification device;

FIGS. 4A-4B are longitudinal cross sectional views through a cylindrical air flow modification device actuating differently from that shown in FIGS. 3A-3C;

FIGS. 5A-5C illustrate in cross section an illustrative air cell battery with an associated air flow modification device; and

FIG. 6 shows schematically another illustrative embodiment.

### DETAILED DESCRIPTION

The following detailed description should be read with reference to the drawings. The drawings, which are not necessarily to scale, depict illustrative embodiments and are not intended to limit the scope of the invention.

As noted above, high humidity and/or heat can degrade the performance of an air cell battery. Several of the following embodiments are illustrated in the context of controlling air flow into an air cell to reduce effects of high humidity and/or heat on performance. While this field of use provides a context for illustrating the present invention, it should be understood that the present invention may find applications in a variety of other fields where devices adapted to modify flow impedance are useful.

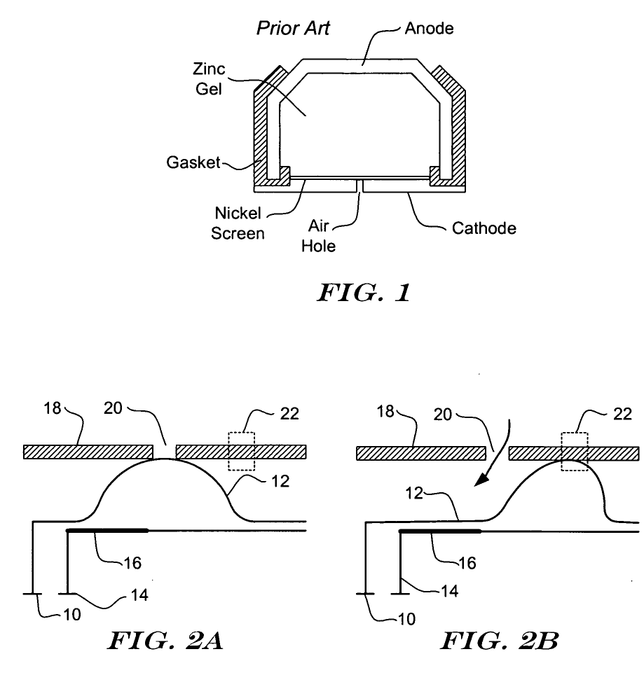

FIG. 1 is a cross sectional view of an illustrative prior art air cell battery, and is more fully discussed above. The gasket provides a seal around the anode and prevents the zinc gel from leaking out, as well as electrically isolating the cathode from the anode. The air cell electro chemistry for a zinc air battery as shown my be summarized as:

Anode: Zn+2OH→ZnO+H₂O+2e⁻

Cathode: O₂+2H₂O+4e^{-b →4}OH

Overall: 2Zn+O₂→2ZnO

As noted in U.S. Pat. No. 4,177,327, the disclosure of which is incorporated herein by reference, most often the metal used in the metal-air cells of metal-air batteries is zinc, but cadmium, iron or other metals may also be used. For the purposes of convenience, the present disclosure discusses primarily zinc-air cells, however, it should be understood that the present invention is not limited to use with this particular chemical species of air cell battery.

FIGS. 2A-2B are plan views for an air flow modification device. As shown in FIG. 2A, a first node 10 is electrically coupled to a first electrode (not shown) on a flexible member 12. A second node 14 is coupled to a second electrode 16 disposed on a wall near the flexible member 12. When in its default or relaxed position, the flexible member 12 is disposed with respect to a wall 18 such that an opening 20 is partly or wholly blocked by the flexible member 12. This may be done, for example, by securing the flexible member 12 to the wall on which the second electrode 16 is disposed such that a ripple is created.

As shown in FIG. 2B, the application of a voltage between the first node 10 and the second node 14 creates an electrostatic force between the first electrode (not shown) on the flexible member 12, and the second electrode 16. This causes the flexible member 12 to move, moving the ripple or bubble of the flexible member 12 away from the opening 20 and reducing the extent of blockage of the opening 20. By such movement, the flow impedance through the opening 20 is changed. In alternative embodiments, the relative positioning of the opening 20 may be moved to position 22 (phantom) such that the flexible member 12 is disposed away from position 22 when relaxed (FIG. 2A), and creates partial or complete blockage when actuated by application of a voltage between the nodes 10, 14 (FIG. 2B).

The flexible member 12 may be, for example, a thin plastic film formed of Kapton® or Mylar®, with a thin electrode formed of aluminum sprayed, printed or otherwise placed thereon, with a dielectric coating provided thereover. If desired, the flexible member 12 may be provided with perforations or openings to allow fluid flow therethrough, though in several embodiments herein the flexible member 12 is fluid impermeable and not perforated. Any suitable construction for a flexible membrane including an electrode component may be used to create a flexible member adapted to actuate under electrostatic forces.

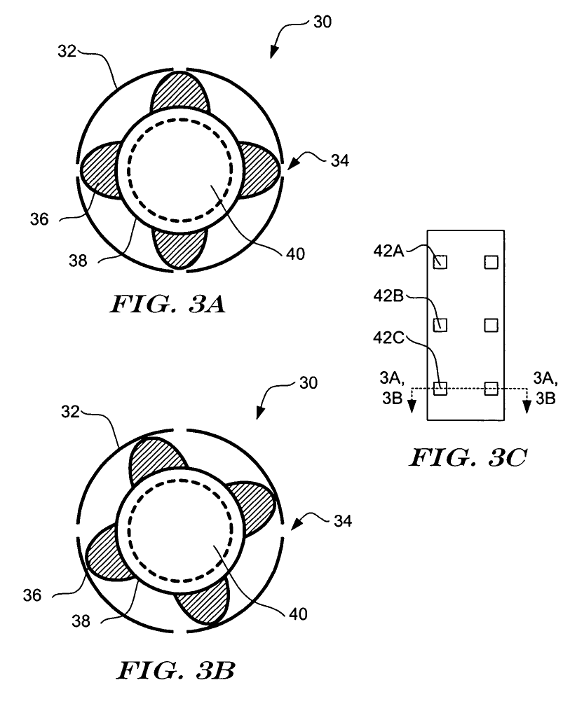

FIGS. 3A-3B are transverse cross sectional views through a cylindrical air flow modification device. The device 30 includes an outer cylinder 32 with openings 34. Several flexible members 36 are located on an inner cylinder 38 at locations corresponding to the openings 34. When in a first position as shown in FIG. 3A, the flexible members 36 partly or wholly block the openings 34. When in a second position as shown in FIG. 3B, the flexible members 36 deflect away from the openings 34, reducing the flow impedance of the cylindrical air flow modification device 30. The deflection in FIGS. 3A-3B is radial in nature. Depending on the design chosen, the deflection may occur by the application of an electrostatic force, or by the removal of an electrostatic force. An air cell battery 40 may be disposed within the inner cylinder 38, with one or more openings (not shown) allowing air flow into the air cell battery.

Rather than having all four of the openings 34 opened or blocked together, each individual opening may be separately addressable by providing separate electrical connections to each. In another embodiment, several sets of openings may be stacked, as shown in FIG. 3C, where each set 42A, 42B, 42C is separately addressable.

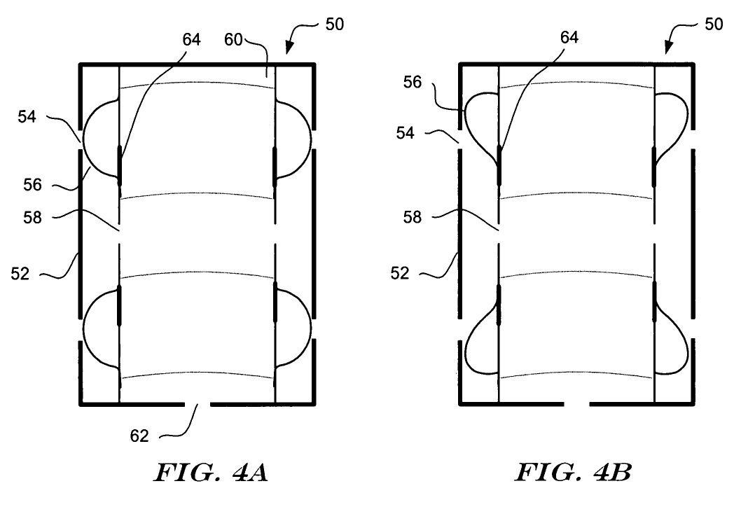

FIGS. 4A-4B are longitudinal cross sectional views through a cylindrical air flow modification device actuating differently from that shown in FIGS. 3A-3C. The device 50 includes an outer cylinder 52 having openings 54. Flexible members 56 are disposed near the openings 54 on an inner cylinder 60 including lateral openings 58 and an axial opening 62. The flexible members 56 include thin electrodes (not shown) disposed thereon. A number of electrodes 64 are disposed on the inner cylinder 60 at locations corresponding to the flexible members 56.

In the configuration illustrated in FIGS. 4A-4B, the relaxed position or default position for the flexible members 56 is as shown in FIG. 4A. Actuation caused by application of a voltage between the voltage on the flexible member 56 and electrode 64 would cause the flexible members 56 to assume the position shown in FIG. 4B. Release of the voltage would terminate the electrostatic force between the electrodes and allow the flexible members 56 to elastically return to their original position as shown in FIG. 4A. By simply changing the relative juxtaposition of the electrode 64, opening 54, and flexible members 56, a configuration wherein the openings 54 are open when the flexible members 56 are in a relaxed state may be created. Instead of the radial movement shown in FIGS. 3A-3B, axial actuation is shown in FIGS. 4A-4B.

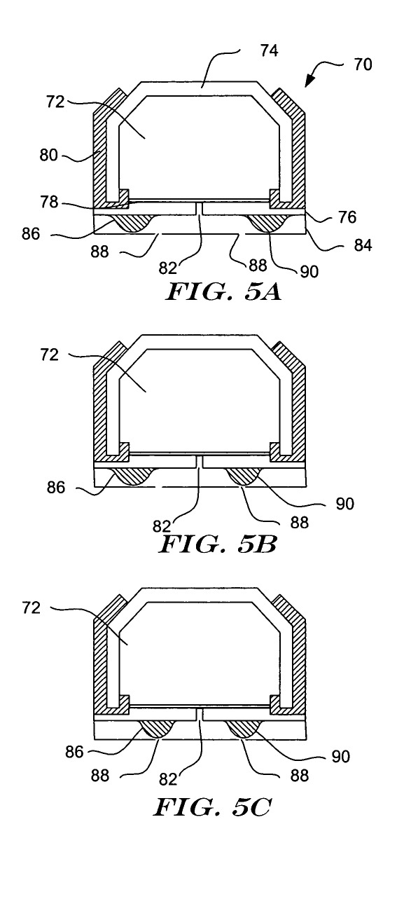

FIGS. 5A-5C illustrate in cross section an illustrative battery having an air cell and an associated air flow modification device. The battery 70 includes an air cell having a reactive substance 72 (such as a zinc gel or other metal suspended in a gel) with an anode cup 74, a cathode 76, a conductive screen 78 for containing the substance 72, and a gasket 80 for isolating the anode cup 74 from the cathode 76 and sealing the substance 72. A cathode opening 82 allows air to enter and react with the substance 72, creating an electric potential between the anode 74 and cathode 76.

The associated air flow modification device includes a chamber wall 84 and flexible members 86, 90. Openings 88 extend through the chamber wall 84 at locations corresponding to the flexible members 86, 90. The flexible members 86, 90 are secured to the chamber wall 84 such that a bubble or ripple is created. The ripple extends out from the chamber wall 84 and crosses most of the chamber at select locations.

In FIG. 5A, both the flexible members 86, 90 are in a relaxed state, creating minimal flow impedance at the openings 88. Going to FIG. 5B, one of the flexible members 90 is actuated (using a method as illustrated above in FIGS. 2A-2B), creating more flow impedance at a corresponding opening 88. The flexible member 90, when actuated may block or substantially block the opening 88, though it is sufficient for the present invention that the flexible member change the flow impedance when compared to what was previously encountered at the opening 88.

Turning to FIG. 5C, the other flexible member 86 is actuated, increasing the flow impedance at its corresponding opening 88, in a manner like that noted with respect to flexible member 90 with reference to FIG. 5B. The three configurations of FIGS. 5A-5C have three different levels of flow impedance, allowing for variability in the air allowed to react with the substance 72. This allows control over incoming humidity and outgassed moisture (high temperatures). If desired, the rate of reactions inside the battery may be controlled as well by this modulation. More particularly, by limiting incoming fresh air flow, the available oxygen for the chemical reactions can be limited to modulate reaction rates.

The air flow modification device illustrated in FIGS. 5A-5C is one in which the default or relaxed position for the flexible members 86, 90 is one in which the openings 88 are unobstructed. This contrasts with some of the embodiments shown in the earlier Figures.

Sensors for temperature and/or humidity may be included in further embodiments, and coupled for controlling the actuation of the flexible members shown above. In some examples, a controller may be used. If desired, and for lower power consumption, logic or even direct control may be used instead.

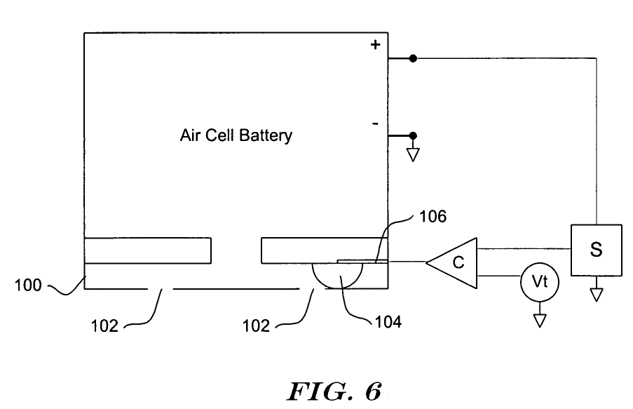

For example, FIG. 6 illustrates schematically an embodiment incorporating a controller. In the illustrative embodiment, an air cell battery (internal components of which are omitted) is coupled with an air flow modification device 100, including walls defining openings 102 and a flexible membrane 104 secured relative an electrode 106. The flexible membrane 104 may include an electrode coupled to relative ground for the system. The air cell battery includes an anode and a cathode output as shown. These are used to power a sensor S, which may be, for example, a micro-electro-mechanical system (MEMS device) adapted to sense temperature or humidity. Such sensors are known in the art and provide low power consumption. The output of the sensor S is compared using a comparator C to a threshold voltage Vt, which may be generated in any suitable manner, for example by the use of a constant voltage device, diode, etc.

The comparator C may be coupled in any suitable manner; for example, if the sensor S provides an output which goes down as either humidity or temperature increases, the comparator C may be configured to provide a high output causing actuation once the sensor output S drops below the threshold voltage Vt. When the comparator C provides a high output to the electrode 106, the flexible member 104 will actuate and shift over to block one of the openings 102, modifying the flow impedance going into the air cell battery. If desired, multiple sensors S may be used, and/or a number of threshold voltages Vt may be provided to allow for actuation of a number of flexible members 104 in series or parallel. It will be clear to those skilled in the art that a number of configurations are possible, and that shown in FIG. 6 is merely illustrative of one manner in which a sensor S may be coupled to control a flow modification device 100 to provide improved performance of the air cell battery without undue power consumption.

Those skilled in the art will recognize that the present invention may be manifested in a variety of forms other than the specific embodiments described and contemplated herein. Accordingly, departures in form and detail may be made without departing from the scope and spirit of the present invention as described in the appended claims.

What is claimed is:

1. A battery comprising:
an air cell having an anode, a cathode, a substance reactive to air, and an opening allowing for introduction of air to react with the substance; and
a flow control device coupled to the opening and having an adjustable flow impedance for controlling air flow into the air cell, the flow control device comprising:
an opening;
a first electrode;
a flexible member; and
a second electrode disposed on the flexible member;
wherein:
the flexible member is configured to have a first position and a second position, the first position being a default position;
the electrodes are placed such that a voltage applied between the electrodes can cause the flexible member to assume the second position due to an electrostatic force; and
the first position and the second position create different flow impedances through the opening.

2. The battery of claim 1 further comprising a sensor for sensing an environmental condition, the sensor being coupled to the flow control device to provide a signal for modifying air flow into the air cell.

3. The battery of claim 1 wherein the air cell is defined in a cylindrical shape, and the flow control device is formed with a cylindrical member forming a chamber about the air cell.

4. The battery of claim 3 wherein:
the cylindrical member axially surrounds the air cell;
the cylindrical member includes an outer opening therein;
a flexible membrane is disposed between the air cell and the cylindrical member, the flexible membrane disposed such that, when in a first position, the outer opening is substantially blocked, and when in a second position, the outer opening is not substantially blocked; and
movement of the flexible membrane between the first and second position can be effected by applying a voltage between an electrode disposed on the flexible membrane and a second electrode.

5. The battery of claim 4 wherein the second electrode is disposed on an outer casing of the air cell.

6. An air flow modification device comprising:
an outer casing having a plurality of outer openings therethrough;
flexible membranes corresponding to each of the outer openings, each flexible membrane including a first electrode; and
a plurality of second electrodes each corresponding to a first electrode;
wherein the flexible membranes and second electrodes are disposed with respect to one another such that, for a given flexible membrane having a first electrode and a corresponding second electrode, the flexible membrane is moveable with respect to a corresponding outer opening to change the flow impedance through the corresponding outer opening in response to a voltage applied between the corresponding first and second electrodes.

7. The device as in claim 6 wherein the plurality of first and second electrodes are individually addressable.

8. The device of claim 6 wherein the outer casing is in the form of an outer cylinder, the device further comprising an inner cylinder to which the second electrodes and the flexible membranes are attached.

9. The device of claim 8 wherein the flexible membranes are attached to the inner cylinder such that the flexible membrane is moveable in a direction about the cylinder.

10. The device of claim 8 wherein the flexible membranes are attached to the inner cylinder such that the flexible membrane is moveable in an axial direction with respect to the cylinder.

11. The device of claim 8 wherein the inner cylinder includes an opening, wherein the inner cylinder and outer cylinder form a chamber having inlets in the outer cylinder and an outlet in the opening in the inner cylinder.

12. A battery comprising:
the device of claim 11; and
an air cell disposed in the inner cylinder.

13. The device of claim 6 wherein the flexible membranes are configured with respect to the openings and the second electrodes such that, when a voltage is applied between the first and second electrodes, the openings are substantially closed.

14. The device of claim 6 wherein the flexible membranes are configured with respect to the openings and the second electrodes such that, when a voltage is applied between the first and second electrodes, the openings are substantially opened and, when the voltage is removed, the openings are substantially closed.

15. A method of controlling an air cell battery, the air cell battery having an inlet allowing for infusion of air, the method comprising:
providing an air flow modification device coupled to the inlet; and
modulating air flow through the inlet by adjusting air flow impedance through the air flow modification device;
wherein the air flow modification device comprises:
a first wall defining a flow opening;
a second wall opposite the first wall;
a flexible membrane secured to the first wall and disposed relative the flow opening, the flexible membrane being moveable to modify flow impedance through the flow opening, the flexible membrane including a first electrode; and
a second electrode disposed relative the second wall;
wherein the second electrode is disposed relative the flexible membrane such that application of a voltage between the first and second electrodes creates an electrostatic force modifying the flow impedance through the flow opening; and
wherein the step of modulating air flow includes selectively applying a voltage between the first and second electrodes.

16. The method of claim 15 further comprising sensing an environmental condition, wherein the step of modulating air flow is performed in response to the sensed environmental condition.

17. The method of claim 16 wherein the step of modulating air flow is performed to maintain a constant output voltage for the air cell battery.

18. A method of controlling an air cell battery, the air cell battery having an inlet allowing for infusion of air, the method comprising:
providing an air flow modification device coupled to the inlet; and
modulating air flow through the inlet by adjusting air flow impedance through the air flow modification device;
wherein the air flow modification device comprises:
an outer casing having a plurality of outer openings therethrough;
flexible membranes corresponding to each of the outer openings, each flexible membrane including a first electrode; and
a plurality of second electrodes each corresponding to a first electrode;
wherein the flexible membranes and second electrodes are disposed with respect to one another such that, for a given flexible membrane having a first electrode and a corresponding second electrode, the flexible membrane is moveable with respect to a corresponding outer opening to change the flow impedance through the corresponding outer opening in response to a voltage applied between the corresponding first and second electrodes.

19. A method of operating an air cell battery having an air entry structure comprising modifying the air flow impedance into and through the air entry structure by electrostatic actuation of a moveable membrane.

20. The method of claim 19 further comprising sensing an environmental condition, wherein the step of modifying air flow impedance is performed in response to sensing the environmental condition.
